(19) United States
(12) Patent Application Publication
(10) Pub. No.: US 2011/0134826 A1
(43) Pub. Date: Jun. 9, 2011

(54) RELAY DATA PATH ARCHITECTURE FOR A WIRELESS NETWORK

(76) Inventors: Xiangying Yang, Portland, OR (US); Muthaiah Venkatachalam, Beaverton, OR (US)

(21) Appl. No.: 12/872,808

(22) Filed: Aug. 31, 2010

Related U.S. Application Data
(60) Provisional application No. 61/266,887, filed on Dec. 4, 2009.

(51) Int. Cl. H04B 7/14

(52) U.S. Cl. 370/315

(57) ABSTRACT

A system and method for forming a relay data path architecture in a wireless network is disclosed. The method comprises forming a separate layer-three data link in a wireless network between a relay station, a base station and an access service network gateway (ASN-GW). Each separate layer-three data link is mapped from the ASN-GW to a next element in the wireless network to form a data path from the ASN-GW to the relay station. Data packets can be sent between a mobile station and the ASN-GW through each layer-three data link using a tunneling protocol such that each layer-three data link forms a separate tunnel.

### CLAIM OF PRIORITY

Priority of U.S. Provisional patent application Ser. No. 61/266,887 filed on Dec. 4, 2009 is claimed.

### BACKGROUND

The speed and processing power of mobile computing devices are escalating. The increased capabilities of mobile computing devices have enabled the devices to transition from textual displays to graphical displays and more recently to displaying multimedia such as streaming videos and mobile television. The ability to download and display multimedia on mobile communication devices necessitates a significant increase in wireless communication speeds for the mobile computing devices.

One way that wireless communication speeds have been increased is through the use of higher frequency bands, often greater than 2 gigahertz (GHz). The higher frequency bands allow for the use of a signal with wider bandwidth, thereby enabling faster wireless communication speeds. However, signals transmitted in the higher frequency bands also attenuate more quickly in the atmosphere relative to lower frequency signals. Wireless communication networks are typically comprised of base stations that transmit over a selected area commonly referred to as a cell. The result of using higher frequencies is a smaller cell size and the need for more base stations. However base stations are relatively expensive to construct, operate and maintain.

One way to reduce the costs of operating additional base stations is to introduce the use of relay stations. Relay stations can receive a wireless signal from a user's mobile station, boost the signal's power, and transmit the signal to additional relay station(s) or a base station. Relay stations can be constructed and operated for a reduced price relative to base stations. The use of relay stations and base stations forms a “multi-hop” wireless communication network in which signals from mobile stations wirelessly hop between relay station(s) and the base station. However, the architecture designed for data transmission in a standard wireless communication that occurs directly between a mobile station and a base station is not optimal for use in a multi-hop wireless communication infrastructure.

### BRIEF DESCRIPTION OF THE DRAWINGS

Features and advantages of the invention will be apparent from the detailed description which follows, taken in conjunction with the accompanying drawings, which together illustrate, by way of example, features of the invention; and, wherein:

FIG. 1 illustrates a block diagram of a generic non-mesh relay network;

FIG. 2 illustrates a block diagram of a generic mesh relay network;

FIG. 3 illustrates a block diagram of a non-relay wireless network;

FIG. 4 illustrates a block diagram of a user plane data path system for a wireless relay network in accordance with an embodiment of the present invention;

FIG. 5 illustrates a block diagram of a relay wireless network having a user plane data path system in accordance with an embodiment of the present invention;

FIG. 6 illustrates an example process for establishing a data path through separate tunnels in the system of FIG. 5 in accordance with an embodiment of the present invention;

FIG. 7 illustrates an example of reuse of a tunnel in the user plane data path system in accordance with an embodiment of the present invention; and

FIG. 8 provides a flow chart depicting a method for forming a relay data path in a wireless network in accordance with an embodiment of the present invention.

Reference will now be made to the exemplary embodiments illustrated, and specific language will be used herein to describe the same. It will nevertheless be understood that no limitation of the scope of the invention is thereby intended.

### DETAILED DESCRIPTION

Before the embodiment(s) of the present invention are disclosed and described, it is to be understood that the embodiment(s) disclosed are not limited to the particular structures, process steps, or materials disclosed herein, but is extended to equivalents thereof as would be recognized by those ordinarily skilled in the relevant arts. It should also be understood that terminology employed herein is used for the purpose of describing particular embodiments only and is not intended to be limiting.

### Definitions

As used herein, the term “substantially” refers to the complete or nearly complete extent or degree of an action, characteristic, property, state, structure, item, or result. For example, an object that is “substantially” enclosed would mean that the object is either completely enclosed or nearly completely enclosed. The exact allowable degree of deviation from absolute completeness may in some cases depend on the specific context. However, generally speaking the nearness of completion will be so as to have the same overall result as if absolute and total completion were obtained. The use of “substantially” is equally applicable when used in a negative connotation to refer to the complete or near complete lack of an action, characteristic, property, state, structure, item, or result.

As used herein, the term “about” is used to provide flexibility to a numerical range endpoint by providing that a given value may be “a little above” or “a little below” the endpoint.

As used herein, the term “layer-two” data link refers to a data link formed based on the Layer 2 specification of the seven-layer OSI model of computer networking.

As used herein, the term “layer-three” data link refers to a data link formed based on the Layer 3 specification of the seven-layer OSI model of computer networking.

### Example Embodiments

An initial overview of technology embodiments is provided below and then specific technology embodiments are described in further detail later. This initial summary is intended to aid readers in understanding the technology more quickly but is not intended to identify key features or essential features of the technology nor is it intended to limit the scope of the claimed subject matter. The following definitions are provided for clarity of the overview and embodiments described below.

The use of higher frequency carrier signals to boost signal bandwidth inherently reduces the distance a signal can travel through the atmosphere. Higher frequency signals are more readily absorbed by the water vapor in the atmosphere. In a typical cellular structure, each mobile phone, referred to herein as a mobile station (MS), communicates directly with a base station (BS). When the frequency is increased, thereby reducing the distance the signal can travel, the distance over which the base station can communicate is reduced, thereby creating a need for additional base stations to provide adequate wireless communications over a selected geographic region. However, the construction, installation, and maintenance of base stations can be relatively expensive.

The use of relay stations can reduce the need to install as many base stations. Relay stations can be implemented in a wireless communication infrastructure to increase the cell size of a base station and reduce the number of base stations needed to provide adequate coverage over a selected area.

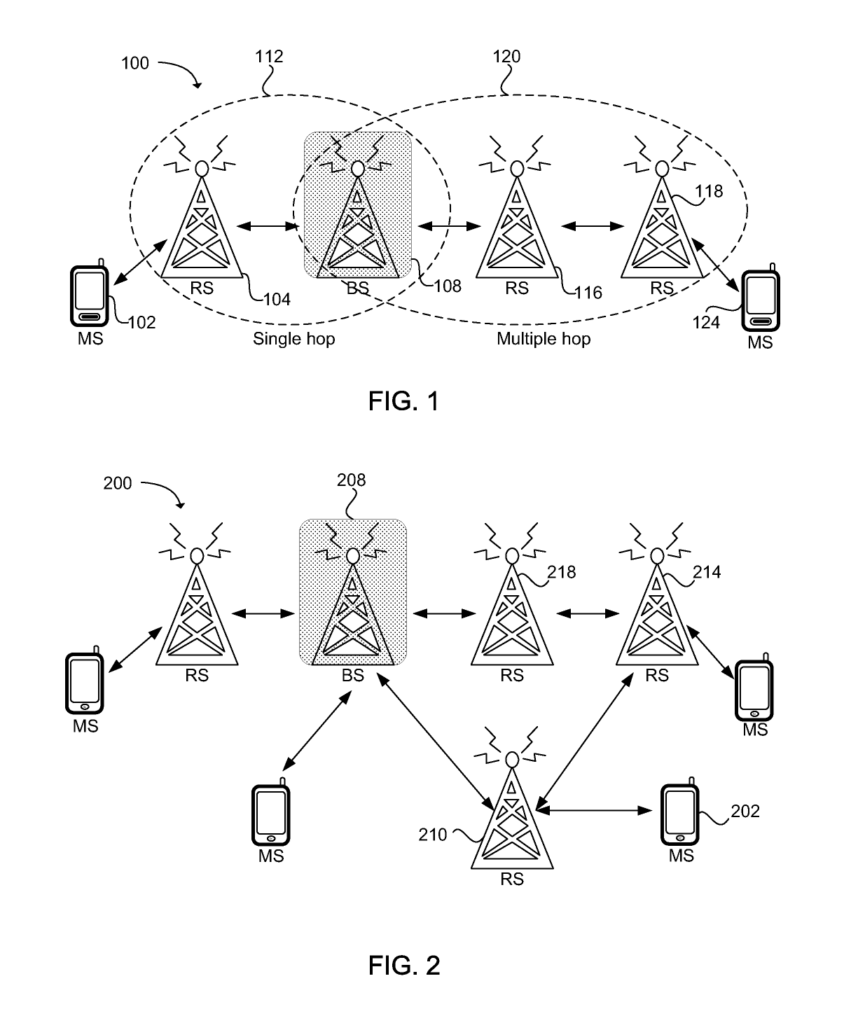

For instance, FIG. 1 illustrates a generic non-mesh relay network 100. In this relay network the signal from a mobile station 102 is transmitted to a relay station 104. The relay station 104 then transmits the mobile station's signal to the base station 108. When the mobile station's signal is relayed to the base station through a single relay station, it is typically referred to as a single-hop 112 transmission. When the signal from a mobile station 124 is relayed to the base station 108 through multiple relay stations 116, 118 then it is referred to as a multiple hop transmission 120. When there is only a single potential path for a signal from a mobile station 102, 124 to be relayed to the base station 108, it is referred to as a non-mesh network, as shown in FIG. 1.

FIG. 2 shows a generic mesh relay network 200. In a mesh relay network, the signal from a mobile station may be communicated to a base station 208 through multiple paths. For instance, the mobile station's 202 signal may travel a single-hop route through relay station 210. Alternatively, the mobile station's 202 signal may travel a longer route, through relay stations 210, 214 and 218 to base station 208. In a mesh network, additional logic is typically needed to enable signals to be routed through optimal paths to the base station based on variables such as distance, signal congestion, signal power, and so forth.

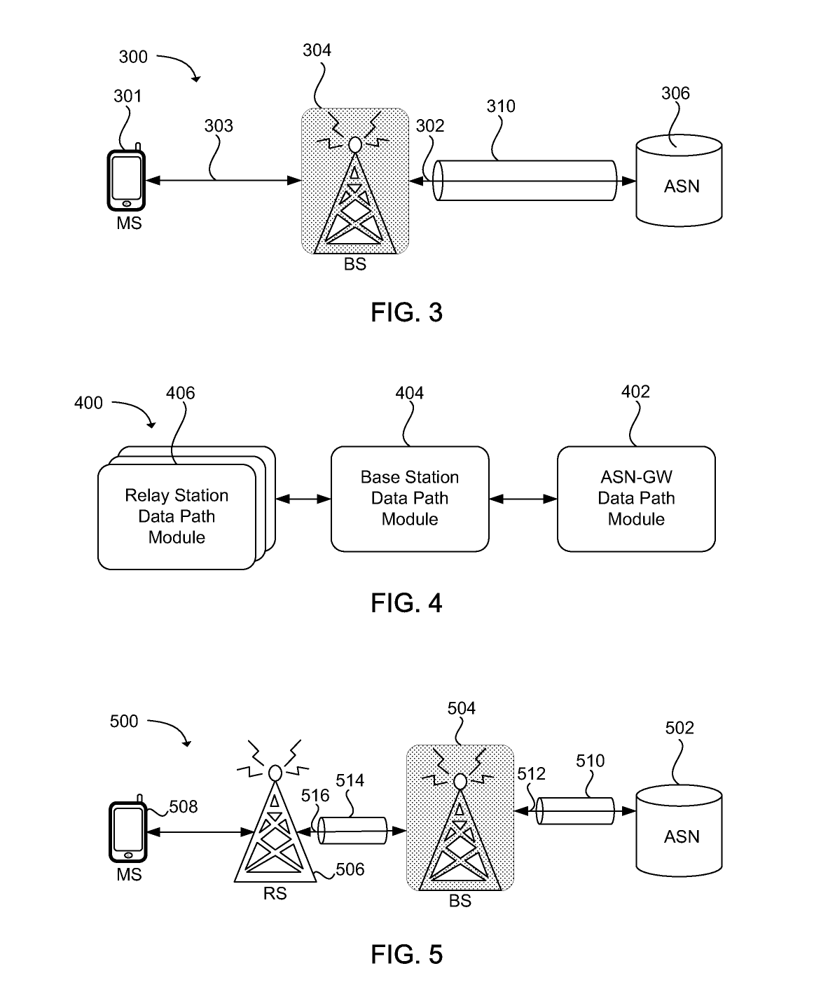

In a known non-relay wireless network, a user plane data path is formed between a base station and an access service network (ASN) gateway. For instance, FIG. 3 shows a typical non-relay wireless network 300. Information traveling through a wireless communication channel 303 formed between a mobile station 301 and a base station 304 is identified based on a flow ID value. A mapping function is used at the base station 304 to downlink or uplink data to or from an air link connection with the wireless communication channel 303. The mapping of the flow ID on the wireless communication channel 303 and the data channel 310 at the base station 304 is established when the mobile station 301 and the base station 304 establish a new connection on 310 corresponding to a service flow for the mobile station via an end-to-end protocol.

An end-to-end protocol connection is created by forming layer-two data links 303, 302 between the mobile station 301 and the base station 304 and between the base station 304 and the ASN gateway 306, respectively. Internet Protocol (IP) data is directly transmitted via the layer-two data link 303 between the mobile station 301 and the base station 304. The data is then “wrapped” by an outer tunnel 310 so that the data can be delivered between the base station 304 and the ASN gateway 306 without the need for the base station 304 to perform classification on the IP data sent from the mobile station 301. The classification is typically performed by the ASN gateway 306.

The ASN gateway 306 classifies incoming IP packets from an Internet connection (not shown) based on the mobile station's IP address and ports. The IP packets are then mapped to the corresponding tunnel 310 serving the mobile station 301. The base station 304 can then perform de-tunneling and deliver the IP packets to the mobile station 301 using layer-2 Media Access Control (MAC) transmission on the wireless communication channel 303. The packet handling in the outgoing direction (from the mobile station to the Internet) is similar.

When relay stations are introduced into a wireless communication system, the additional hops through which the data travels often uses additional routing information and other header information sent in the header of each packet. The header information can include information detailing the path over which the packet is intended to travel, payload information, connection setup information, and so forth.

The type of data link over which the packets travel can also determine the amount of header information. For instance, in a layer-two data connection, the base station typically maintains an individual MAC state machine for each connection in a data link, whether the data connection is directly associated with the base station or with another relay station. This can use many relay-specific designs which can add increased complexity to the relay network.

In order to reduce the amount of overhead and complexity in the header of packets that are communicated over a relay network, a user plane data path system for a wireless relay network is disclosed. An example block diagram 400 of a user plane data path system is illustrated in FIG. 4. The system comprises an access service network gateway (ASN-GW) data path module 402 that is configured to communicate with a base station to set up a first layer-three (L-3) data link and run a tunneling protocol, such as generic routing encapsulation (GRE), between the ASN-GW and the base station. A base station data path module 404 can be configured to communicate with a relay station to set up a second layer-three data link between the base station and the relay station, which is typically also running the same tunneling protocol as that between the base station and the ASN-GW. A relay station data path module 406 can be configured to communicate with the base station to set up the second layer-three data link. Data for a selected service flow is transmitted between a mobile station, the relay station, the base station and the ASN-GW via the first and second layer-three data links. The formation of the layer-three data links will be discussed more fully below.

While examples are given using terminology reflected in the WiMAX Forum NWG specification version 1.5 and the Institute of Electrical and Electronics Engineers (IEEE) 802.16 standard, such as the 802.16-2009 standard published May 29, 2009, this is not intended to be limiting. The use of multiple separate layer-three data links can be applied to any type of wireless digital communication network using relays, such as the architecture reflected in the 3GPP 2010-06 specification, or associated versions of the specification. The terminology used herein can be mapped to the 3GPP specification, such as: mobile station (MS)→user equipment (UE), base station (BS)→evolved node B (eNB), Access Service Network (ASN)→serving gateway and packet data network gateway, generic routing encapsulation (GRE)→general packet radio services (GPRS) tunneling protocol (GTP), and so forth, as can be appreciated.

An example illustration of a relay data network 500 is provided in FIG. 5. A data tunnel can be effectively established between the ASN-GW 502 and the relay station 506 for each service flow. The data tunnel is comprised of a first tunnel 510 formed on a first layer-three data link 512 with a selected tunneling protocol. The type of tunneling protocol used can depend on the type of wireless communication network standard used to implement the network.

For instance, when a network is constructed based on a Worldwide interoperability for Microwave Access (Wimax) Network working group (NWG) specification, such as the Wimax NWG version 1.5 specification, then generic routing encapsulation (GRE) may be used as the tunneling protocol to package

IP packets for communication from the ASN-GW 502 to the relay station 506. When a network is constructed based on the 3GPP architecture, then general packet radio services (GPRS) tunneling protocol (GTP) may be used. Additional types of tunneling protocols may be used as well.

Returning to the example illustration of FIG. 5, a second tunnel 514 can be formed on the second layer-three data link 516 with the selected tunneling protocol. The data tunnel terminates at the relay station so that there is no layer two MAC identity for the mobile station (508) needed in the header of each packet transmitted through the data tunnel on relay station to relay station links or relay station to base station links. Each data tunnel is separate from other data tunnels. Each tunnel can be assigned an independent tunnel key. The tunneling follows the same hop-by-hop design as used in modern wireless networks, where each data tunnel does not extend beyond one hop.

Data for a selected service flow may be transmitted from the mobile station 508 to the relay station 506, the base station 504 and the ASN-GW 502 via the first 510 and second 514 data tunnels. Service flow is the level of granularity provided in which a network can control the quality of service (QoS). When tunnels are formed, such as the first and second data tunnels 510, 514, a single service flow may be assigned to each tunnel. Alternatively, multiple service flows, such as each service flow for a selected mobile station, may be mapped to each separate tunnel.

The base station 504 can map data from one hop to another. The intermediate node, such as the relay station 506, the base station 504, or the ASN-GW 502, can perform unique mapping from one tunnel to another tunnel. If desired, additional outer header compression may be performed on each wireless hop to reduce tunneling overhead. For instance, outer header compression may be performed on the second data tunnel 514 on the relay link. Additional compression may not be needed for tunnels formed on wired links, such as the first data tunnel 510 located between the base station 504 and the ASN gateway 502.

The data path design described above using separate layer-three data links maintains a simple, flat architecture regardless of the number of relay hops or the topology of the wireless network. For instance, the data path design can be used in a mesh relay network, such as the example shown in FIG. 2. Since each tunnel is independent, the use of three relay stations 210, 214, 218 to communicate the signal from the mobile station 202 to the base station 208 does not increase the amount of header information. Rather, the relay station data path module 406 (FIG. 4), which can be located in each relay station, can communicate with the adjacent relay station or mobile station to establish a data tunnel comprising a layer-three data link operable to transmit encapsulated data packets.

The Wimax network reference model includes eight reference points that are conceptual links that connect two functional entities in the network. Reference points represent a bundle of protocols between peer entities, similar to an IP network interface. Interoperability is enforced through reference points without dictating how vendors implement the edges of those reference points. The references are well documented in the Wimax specification. A summary of reference points discussed in the present application is provided below for convenience.

R6—consists of a set of control and bearer plane protocols for communication between the base station and the ASN GW.

R8—consists of a set of control plane message flows and, in some situations, bearer plane data flow forwarding between base stations.

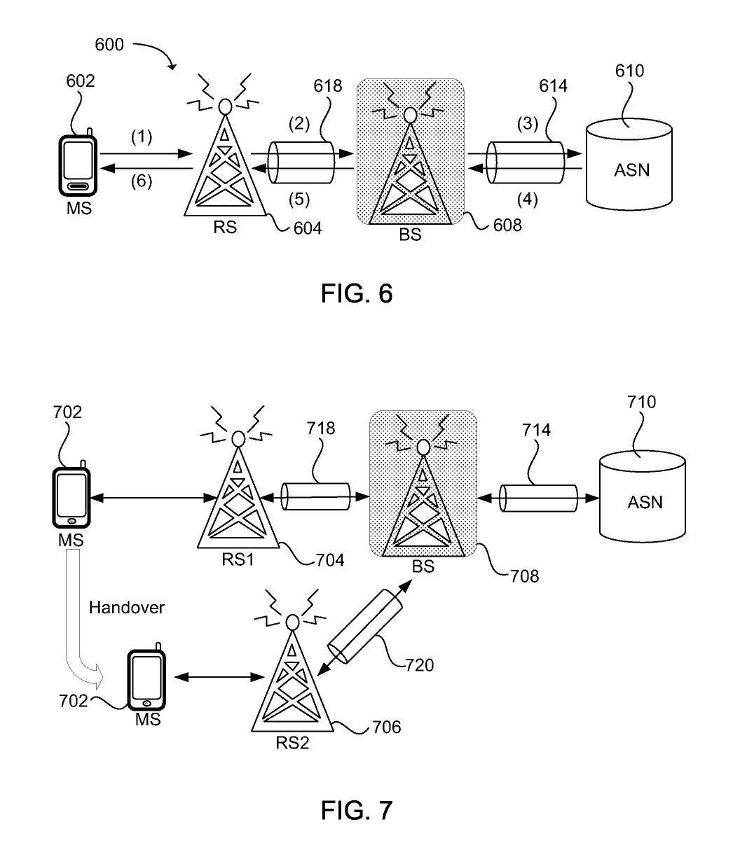

The initial data path setup to form the data tunnels 510, 514 illustrated in FIG. 5 can be accomplished in a hop-by-hop fashion. One exemplary process for establishing a data path through separate tunnels from one or more relay stations to the ASN-GW is illustrated in FIG. 6. An establishment of the data path can be accomplished through the following steps:

(1) A mobile station 602 can send a request message, such as a dynamic service addition request (DSA_REQ) message, to the mobile station's serving relay station 604, requesting a new connection/service flow setup.

(2) Based on the received request, the relay station 604 seeks to create and establish a new tunnel for this service flow in the network. The relay station 604 can send a Datapath_Reg message via the R8 reference connection to the parent base station 608. It should be noted that the Datapath_Reg message may be relayed over several relay stations to the parent base station.

(3) Upon receiving the message from the relay station 604, the base station 608 sends a Datapath_Reg message via an R6 reference connection to the serving ASN-GW 610. It is assumed that the serving ASN-GW is the anchor ASN. Otherwise, the message can be relayed to the anchor ASN_GW.

(4) The ASN-GW 610 can perform proper quality of service (QoS) provisioning and admission control, as can be appreciated. Upon successful completion, the ASN-GW can reply to the Datapath_Reg message from the base station 608 with a datapath acknowledgement (Datapath_Ack) message via the R8 reference connection, thereby establishing a first tunnel 614.

(5) The base station 608 can reply to the relay station's Datapath-Reg message with a Datapath_Ack message via the R8 reference connection to establish a second tunnel 618.

(6) The relay station 604 can reply to the mobile station 602 with a dynamic service addition response (DSA RSP) message to notify the mobile station of a successful connection and service flow establishment between the mobile 602 station and the ASN-GW 610 via the first and second tunnels 614, 618.

While specific types of messages, such as DSA formatted messages, are identified in the example above, it should be noted that a variety of different types of messages may be used to establish the data paths, as can be appreciated.

In one embodiment, payload header suppression (PHS) may be used to reduce the size of the header. In steps (2) and (5) outer PHS can be set up between the relay station 604 and the base station 608 to suppress a tunnel header used for data packets transmitted through the second tunnel 618. An inner PHS can be set up between the ASN-GW 610 and the mobile station 602 to suppress a payload IP header.

During handover of the mobile signal from one relay station to another relay station, the data path is switched so that a new tunnel will terminate at the new serving relay station. In general, the current network framework can readily support his feature. Previously, each time during handover, an old data path established between the mobile station via the old serving station was torn down and replaced with a new data path via the new serving station.

In accordance with an embodiment of the present invention, data path switching can be further optimized for intra-base station handover cases. Intra-base station handover occurs when the signal communication from the mobile station to one relay station is switched to another relay station or from one relay station to a base station located within the same serving base station cell.

For example, FIG. 7 provides an illustration of an exemplary handover process where a mobile station 702 performs a handover from a first relay station 704 to a second relay station 706 that are within the cell of the same base station 708. Instead of setting up new tunnels all the way from the ASN-GW 710 to the second relay station 706 that replaces both the first and second tunnels 714, 718, the first tunnel 714 can be reused after the handover. The base station 708 can set up a third tunnel 720 via a reference R8 connection between the second relay station 706 and the base station 708 during the mobile station's intra-cell handover. The establishment of the third tunnel 720 can be substantially transparent to the ASN-GW 710. A security update can be communicated through a c-plane to an anchor authenticator in the ASN-GW. Tunnel reuse can save network overhead and set up latency when a handover occurs.

The same approach can be generalized to other handover scenarios. If a handover occurs from the first relay station 704 to the base station 708 then the base station can reuse the first tunnel 714 and simply tear down the second tunnel 718. If a handover occurs from the base station to the first relay station, then the base station can reuse the first tunnel and set up the second tunnel 718, as previously discussed. More generally, when the data path is changed in a relay network due to a handover, single hop tunnel sections that remain in the data path can be reused.

When a secure tunnel protocol is used, such as internet protocol secure (IPSec), the security associations can also terminate hop-by-hop. More specifically, secured tunnels are maintained between the ASN-GW and the base station and the base station and the relay station, respectively. Encrypted information such as a GRE key can still be known to middle nodes and the base station. The base station can then perform proper QoS mapping and set up header compression schemes to reduce the tunnel overhead.

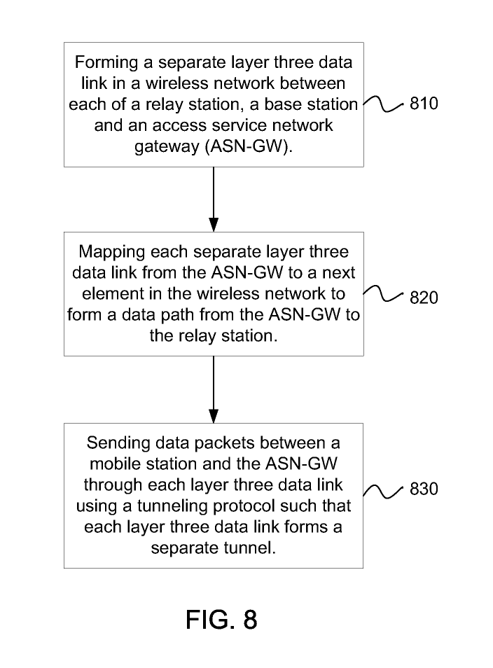

In another embodiment, a method 800 for forming a relay data path architecture in a wireless network is disclosed, as depicted in the flow chart of FIG. 8. The method comprises forming 810 a separate layer-three data link in a wireless network between each of a relay station, a base station and an access service network gateway (ASN-GW). For instance, FIG. 5 shows two separate layer-three data links 512 and 516. Each layer-three data link is an individual data link that is not dependent on or connected to the other layer-three data links.

The method 800 includes mapping 820 each separate layer-three data link from the ASN-GW to a next element in the wireless network to form a data path from the ASN-GW to the relay station. The next element may be an additional ASN-GW, a base station, or a relay station. The process discussed with respect to FIG. 6 can be used to map each separate layer-three data link. Each layer-three data link can be assigned a separate identification value. A separate data path can be formed for each service flow. Alternatively, multiple service flows, such as all of the service flows from a selected mobile station, may be communicated through each separate layer-three data link.

The method 800 includes the additional operation of sending 830 data packets between a mobile station and the ASN-GW through each layer-three data link using a tunneling protocol such that each layer-three data link forms a separate tunnel. For instance, tunneling protocols such as a generic routing encapsulation (GRE) protocol or a general packet radio services (GPRS) tunneling protocol (GTP) may be used. Additional tunneling protocols that enable IP packets to be transmitted across the layer-three data links with the necessary header information can also be used.

As previously discussed, tunnels can be reused when a handover occurs. For instance, when an intra-cell handover occurs, the tunnel between the base station and the ASN-GW may be used, while forming one or more new tunnels between the new relay station(s) and the base station. In a relay network wherein a multi-hop communication occurs, more than one tunnel may be reused, as can be appreciated. For instance, selected tunnels such as tunnels formed between relay stations can be reused during a handover when only a single relay station in the multi-hop communication is changed during handover. Each tunnel that is formed between the ASN-GW and the relay station that is serving the mobile station can be reused if it remains in the data path between the mobile station and the ASN-GW after the handover. The reuse of tunnels can significantly reduce overhead and setup latency.

The flexibility and efficiency of data path management via hop-by-hop tunneling provides a significant improvement relative to an end-to end tunneling approach. For data path setup, the setup signaling in an end-to end tunneling approach still travels via the mobile station to the relay station, the base station, and to the ASN in a round trip. However, the base station is not aware of the transaction. Therefore, additional signaling overhead is needed as the relay station and base station need to be notified about the connection setup to properly provision resources on the R8 reference connection and between the relay station and the base station on the R6 reference connection.

During handover, an end-to-end tunneling approach can require the entire tunnel between a first relay station and the ASN to be torn down and a new one placed between the new relay station and the ASN to be set up. No reuse is possible with an end-to-end tunneling approach.

Moreover, when a secured tunnel, such as IPSec is used, the key context will be maintained between RS-ASN. This means that information such as GRE keys are hidden from nodes in the middle, such as the base station. Thus, the base station is not able to identify the GRE tunnel or payload information. Therefore, the base station is not able to perform proper QoS mapping or header compression functions.

It should be understood that some of the functional units described in this specification have been labeled as modules in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions, which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices. The modules may be passive or active, including agents operable to perform desired functions.

Various techniques, or certain aspects or portions thereof, may take the form of program code (i.e., instructions) embodied in tangible media, such as floppy diskettes, CD-ROMs, hard drives, or any other machine-readable storage medium wherein, when the program code is loaded into and executed by a machine, such as a computer, the machine becomes an apparatus for practicing the various techniques. In the case of program code execution on programmable computers, the computing device may include a processor, a storage medium readable by the processor (including volatile and non-volatile memory and/or storage elements), at least one input device, and at least one output device. One or more programs that may implement or utilize the various techniques described herein may use an application programming interface (API), reusable controls, and the like. Such programs may be implemented in a high level procedural or object oriented programming language to communicate with a computer system. However, the program(s) may be implemented in assembly or machine language, if desired. In any case, the language may be a compiled or interpreted language, and combined with hardware implementations.

Reference throughout this specification to “one embodiment” or “an embodiment” means that a particular feature, structure, or characteristic described in connection with the embodiment is included in at least one embodiment of the present invention. Thus, appearances of the phrases “in one embodiment” or “in an embodiment” in various places throughout this specification are not necessarily all referring to the same embodiment.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. In addition, various embodiments and example of the present invention may be referred to herein along with alternatives for the various components thereof. It is understood that such embodiments, examples, and alternatives are not to be construed as defacto equivalents of one another, but are to be considered as separate and autonomous representations of the present invention.

Furthermore, the described features, structures, or characteristics may be combined in any suitable manner in one or more embodiments. In the following description, numerous specific details are provided, such as examples of layouts, distances, network examples, etc., to provide a thorough understanding of embodiments of the invention. One skilled in the relevant art will recognize, however, that the invention can be practiced without one or more of the specific details, or with other methods, components, layouts, etc. In other instances, well-known structures, materials, or operations are not shown or described in detail to avoid obscuring aspects of the invention.

While the forgoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

What is claimed is:

1. A method for forming a relay data path architecture in a wireless network comprising:
forming a separate layer-three data link in a wireless network between each of a relay station, a base station and an access service network gateway (ASN-GW);
mapping each separate layer-three data link from the ASN-GW to a next element in the wireless network to form a data path from the ASN-GW to the relay station; and
sending data packets between a mobile station and the ASN-GW through each layer-three data link using a tunneling protocol such that each layer-three data link forms a separate tunnel.

2. The method of claim 1, further comprising selecting the tunneling protocol from the group consisting of a generic routing encapsulation (GRE) protocol and a general packet radio services (GPRS) tunneling protocol (GTP).

3. The method of claim 1, wherein forming a separate layer-three data link further comprises forming a separate layer-three data link between each of the at least one relay station, the base station and the ASN-GW for each service flow.

4. The method of claim 1, wherein mapping each separate layer-three data link further comprises assigning a tunnel identification value to each separate tunnel.

5. The method of claim 1, wherein mapping each separate layer-three data link from the ASN-GW to a next element in the wireless network further comprises:
mapping a first layer-three data link from the ASN-GW to the base station; and
mapping a second layer-three data link from the base station to the relay station.

6. The method of claim 5, further comprising mapping an additional layer-three data link between each relay station and a next relay station.

7. The method of claim 1, wherein mapping each tunnel further comprises:
sending a service establish request message from the mobile station to the relay station for a new service flow set up.
sending a datapath_reg message from the relay station to the base station via an R8 reference connection;
sending a datapath_reg message from the base station to the ASN-GW via an R6 reference connection;
performing quality of service provisioning and admission control for a new service flow to the mobile station;
sending a datapath_ACK message from the ASN-GW via the R6 reference connection to the base station to establish a first tunnel;
sending a datapath_ACK message from the base station to the relay station to establish a second tunnel; and
sending a service establish response, e.g., DSA response message, from the relay station to the mobile station to notify the mobile station of a successful connection and service flow establishment.

8. The method of claim 7, further comprising sending the datapath_reg message from the relay station to additional relay stations in the wireless network, wherein a last relay station in the relay sends the datapath_reg message to the base station.

9. The method of claim 7, further comprising:
setting up an outer payload header suppression (PHS) or other header compression schemes between the relay station and the base station to suppress a header for the second tunnel; and
setting up an inner PHS, or other header compression schemes, between the ASN-GW and the mobile station to suppress a payload internet protocol (IP) header.

10. The method of claim 1, further comprising reusing selected tunnels during a handover from a first relay station in communication with the base station to a second relay station in communication with the base station.

11. The method of claim 1, further comprising reusing a tunnel formed between the ASN-GW and the base station when a handover is performed between a base station and a relay station connected to the base station.

12. The method of claim 1, further comprising reusing each tunnel formed between the ASN-GW and a relay station that are in a flow of the data packets from the mobile station to the ASN-GW after a handover occurs.

13. A user plane data path system for a wireless relay network, comprising:
an access service network gateway (ASN-GW) data path module configured to communicate with a base station to set up a first layer-three data link between the ASN-GW and the base station;
a base station data path module configured to communicate with a relay station to set up a second layer-three data link between the base station and the relay station; and
a relay station data path module configured to communicate with the base station to set up the second layer-three data link, wherein data for a selected service flow is transmitted between a mobile station, the relay station and the ASN-GW via the first and second layer-three data links.

14. The system of claim 13, wherein the relay wireless network system includes a plurality of relay stations, with each relay station containing a relay station data path module that is configured to communicate with a next relay station to set up a relay station layer-three data link between the relay station and the next relay station.

15. The system of claim 13, wherein the relay wireless network system is comprised of a mesh network containing a plurality of relay stations.

16. The system of claim 13, wherein the relay wireless network system is comprised of a non-mesh network containing a plurality of relay stations.

17. The system of claim 13, wherein the ASN-GW data path module, the base station data path module, and the relay station data path module are each configured to reuse a corresponding layer-three data link when a handover occurs and the corresponding layer-three data link is still within a data path from the mobile station to the ASN-GW.

18. A computer program product, comprising a computer usable medium having a computer readable program code embodied therein, said computer readable program code adapted to be executed to implement a method for forming a relay data path architecture in a wireless network comprising:
forming an individual layer-three data link in a wireless network between each of at least one relay station, a base station and an access service network gateway (ASN-GW);
mapping each individual layer-three data link from the ASN-GW to a next element in the wireless network to form a data path from the ASN-GW to the at least one relay station; and
sending data packets between a mobile station and the ASN-GW through each layer-three data link using a tunneling protocol such that each layer-three data link forms a separate tunnel.

19. The method of claim 18, wherein mapping each separate layer-three data link from the ASN-GW to a next element in the wireless network further comprises:
mapping a first layer-three data link from the ASN-GW to the base station; and
mapping a second layer-three data link from the base station to the a first relay station in the at least one relay station.

20. The method of claim 19, further comprising mapping an additional layer-three data link between the first relay station and a next relay station in the at least one relay station.
